(19) United States
(12) Patent Application Publication
(10) Pub. No.: US 2003/0230004 A1
(43) Pub. Date: Dec. 18, 2003

(54) Batch fluid bed processor

(75) Inventors: Anne Marie Borsavage, New Milford, CT (US); Michael L. Cappola, Wilton, CT (US); George W. Gereg JR., Bethel, CT (US)

Correspondence Address: BOEHRINGER INGELHEIM CORPORATION, 900 RIDGEBURY ROAD, P O BOX 368, RIDGEFIELD, CT, 06877, US

(73) Assignee: Boehringer Ingelheim pharmaceuticals, Inc., Ridgefield, CT

(21) Appl. No.: 10/448,649

(22) Filed: May 29, 2003

Related U.S. Application Data
(60) Provisional application No. 60/389,482, filed on Jun. 17, 2002.

(51) Int. Cl. F26B 17/00

(52) U.S. Cl. 34/576

(57) ABSTRACT

A batch fluid bed processing machine for processing products. The batch fluid bed processing machine has a container and a gas source coupled to a first end of the container. An expansion chamber is coupled to a second end of the container. An expansion funnel having a second open end is coupled to an interface between the expansion chamber and the container. A column is mounted in the container between the expansion funnel and the gas source. A gas stream is passed from the gas source and through the container. Products may be coated or dryed in the gas stream.

### RELATED APPLICATIONS

Benefit of U.S. Provisional Application Serial No. 60/389,482 filed on Jun. 17, 2002 is hereby claimed, which application is incorporated herein by reference.

### BACKGROUND OF THE INVENTION

1. Field of the Invention

The present invention relates to a fluid bed processor and, more particularly to a fluid bed processor for small batches.

2. Brief Description of Related Developments

Fluid bed processors are known in the granulating art. For example, Glatt Air Techniques, Inc. of Ramsey, N.J., USA markets and sells a GPCG multi purpose fluid bed processing tool. The GPCG tool has interchangeable processing chambers for applications such as top spray processing or Wurster processing. The GPCG tool is designed to handle batches in the kilogram range. When undertaking R&D for pharmaceutical applications, smaller batches than the kilogram range are required. In order to process smaller batches, for example, in the less than 100 gram range, a smaller tool is required than a tool such as the GPCG tool. Smaller tools require additional capital investment and may not offer the full capabilities as the GPCG tool, such as being explosion proof for applications requiring flammable solvents such as alcohol or ethanol. Accordingly, there is a desire to provide a batch fluid bed processor capable of processing a wider range of batches for use in both production and R&D pharmaceutical applications.

### SUMMARY OF THE INVENTION

In accordance with one embodiment of the present invention, a batch fluid bed processing machine is provided for processing products. The batch fluid bed processing machine has a container and a gas source coupled to a first end of the container. An expansion chamber is provided and coupled to a second end of the container. An expansion funnel is provided having a second open end coupled to an interface between the expansion chamber and the container. A column is mounted in the container between the expansion funnel and the gas source. A gas stream is passed from the gas source and through the container. Products may be coated or dryed in the gas stream.

In accordance with another embodiment of the present invention, a batch fluid bed processing machine is provided for processing batches of products. The batch fluid bed processing machine has a container and a gas source coupled to the container and adapted to pass a gas stream through the container. An expansion chamber is provided and coupled to the container. An expansion funnel is located at least partially in the container. The expansion funnel has an open upper end and an open lower end, the open upper end being located downstream the open lower end. A larger quantity of products may be dried or coated where the expansion funnel is removed from the container.

In accordance with another embodiment of the present invention, a method of batch fluid bed processing is provided comprising the steps of providing a product container and coupling an expansion chamber to the product container. Steps of then coating, granulating or drying a first quantity of product in the container are then provided. Steps of then removing the first quantity of product from the container and coupling an expansion funnel to the container are then provided. Steps of then coating, granulating or drying a second quantity of product in the container, where the second quantity is less than the first quantity are then provided.

### BRIEF DESCRIPTION OF THE DRAWINGS

The foregoing aspects and other features of the present invention are explained in the following description, taken in connection with the accompanying drawings, wherein:

FIG. 1 is a side schematic section view of a fluid bed processor;

FIG. 2 is a side schematic section view of a batch fluid bed processor;

FIG. 3 is a top view of a distribution plate;

FIG. 4 is a side schematic section view of a batch fluid bed processor; and

FIG. 5 is a top view of a distribution plate.

### DETAILED DESCRIPTION OF THE PREFERRED EMBODIMENTS

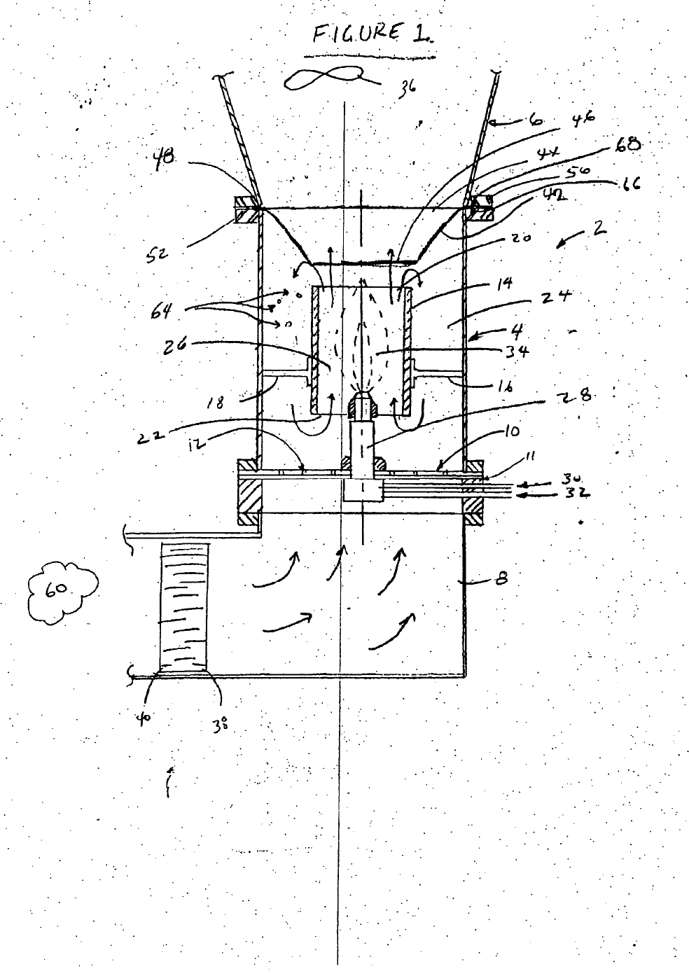

Referring to FIG. 1, there is shown a side section view of a batch fluid bed processor 2 within the teachings of the present invention. Although the present invention will be described with reference to the embodiments shown in the drawings, it should be understood that the present invention can be embodied in many alternate forms of embodiments. In addition, any suitable size, shape or type of elements or materials could be used.

A batch fluid bed processor 2 of the type shown may be adapted to coat, mix and granulate products or substances such as powders and/or liquids. Such powders and/or liquids may be powder components, granulating solutions, bulking agents or active ingredients in the form of powder, liquids or atomized liquids. Alternately, a batch fluid bed processor 2 of the type shown may be adapted to mix and/or granulate other types of products or substances. The batch fluid bed processor 2 may be a Wurster system type or coater that includes a product container section 4, an expansion chamber 6 into which the upper end of the product container section 4 opens at an interface between the container section 4 and expansion chamber 6, and a lower plenum 8 disposed beneath the product container. The upper end of the expansion chamber 6 may open into a filter housing (not shown) including the necessary filter structure and outlet. A distribution plate and/or screen 10 is disposed between the container section 4 and the lower plenum 8. A Wurster coater type system is described in U.S. Pat. No. 5,437,889 that is hereby incorporated by reference in its entirety. The distribution plate or screen 10 has a plurality of passage openings 12 through which air or gas from the lower plenum 8 may pass into the product container section 4. In alternate embodiments, a screen 11 may also be provided upstream of air distribution plate 10. The holes in the plate 10 in the area outside the cylindrical column 14 may be smaller in diameter than the holes beneath the partition or column 14. This results in higher air volumes and velocities in the central area or upbed 26 of container 4 than in the down bed area 24 of container 4. The product container 4 has a cylindrical column 14 supported by spiders 16, 18. Although column 14 is shown with a cylindrical shape, other suitable shapes may be provided in alternate embodiments. Column 14 may be vertically adjustable within container 4 to modify the recirculating behavior of products or particles 64 in container 4 to be coated or dried. The partition or column 14 has open upper and lower ends, 20 and 22. The lower end 22 is spaced above the distribution plate or screen 10. The column or partition 14 divides the interior of the product container section 4 into an outer annular downbed area 24 and interior upbed 26. In alternate embodiments, column or partition 14 may not be provided. A spray nozzle assembly 28 is mounted at or through the distribution plate 10 and projects upwardly into the interior of the cylindrical partition or column 14 and the upbed 26. The spray nozzle 28 receives a supply of gas under pressure through a gas supply line 30 and coating liquid line under pressure through a liquid supply line 32. The spray nozzle assembly 28 discharges a spray pattern 34 of gas and coating liquid. For coating applications, spray nozzle 28 is active. For drying applications, spray nozzle 28 is inactive. Air or gas is introduced into lower plenum 8 from blower or fan assembly 36. Fan assembly 36 draws air or gas into the plenum 8 from an upstream gas source 60. Fan Assembly 36 may be fixed speed or a variable speed type to allow control of gas flow or pressure through plenum 8. Air or gas may be filtered and/or heated by passing through heat exchanger 38 and/or filter 40. Heat exchanger 38 may be fixed in the amount of heat to be transferred to the air or gas or in alternate embodiments may be variable to allow more or less heat to be transferred to the air or gas. Air or gas introduced into the lower plenum 8 passes upwardly through the openings 12 formed through the air distribution plate or screen 10. Products or substances 64 such as powders and/or liquids that are to be coated, mixed, granulated or dryed are placed in product container 4 while air or gas is circulated through container 4. Particles passing upwardly that enter into the spray pattern 34 are coated when spray pattern 34 is active.

To reduce the amount of product or substances to be processed in a given batch, an expansion funnel 42 is inserted and located downstream column or partition 14. Expansion funnel 42 has an open upper end 44 and an open lower end 46 with the open upper end 44 being located downstream the open lower end 46. In the embodiment shown, expansion funnel 42 is conical in shape. In alternate embodiments, any suitable shape may be provided. The open upper end 44 of expansion funnel 42 has a flange 48 captured at the interface between the flange 52 of the upper end of the product container section 4 and the flange 56 of the lower end of expansion chamber 6. Seal 64 and/or seal 66 may be provided to seal flange 52 to flange 56 and/or flange 48 of expansion funnel 42. By inserting expansion funnel 42 into the batch fluid bed processor 2, the effective area of the base of expansion chamber 6 is reduced from the cross section area of the opening in flange 56 to the cross section area of lower end 46 of expansion funnel 42. As a result, smaller quantities of product may be processed in the batch fluid bed processor 2 with the combination expansion chamber 6 and expansion funnel 42 than with the expansion funnel 42 not present. With the use of expansion funnel 42, a tool that is designed to handle larger batches, such as in the kilogram range, may be easily modified in order to process smaller batches, for example, in the less than 100 gram range without having to supply a smaller tool that requires additional capital investment and may not offer the full capabilities of the larger tool. As a result, a batch fluid bed processor can be made capable of processing a wider range of batches allowing the same tool for use in both production and R&D pharmaceutical applications.

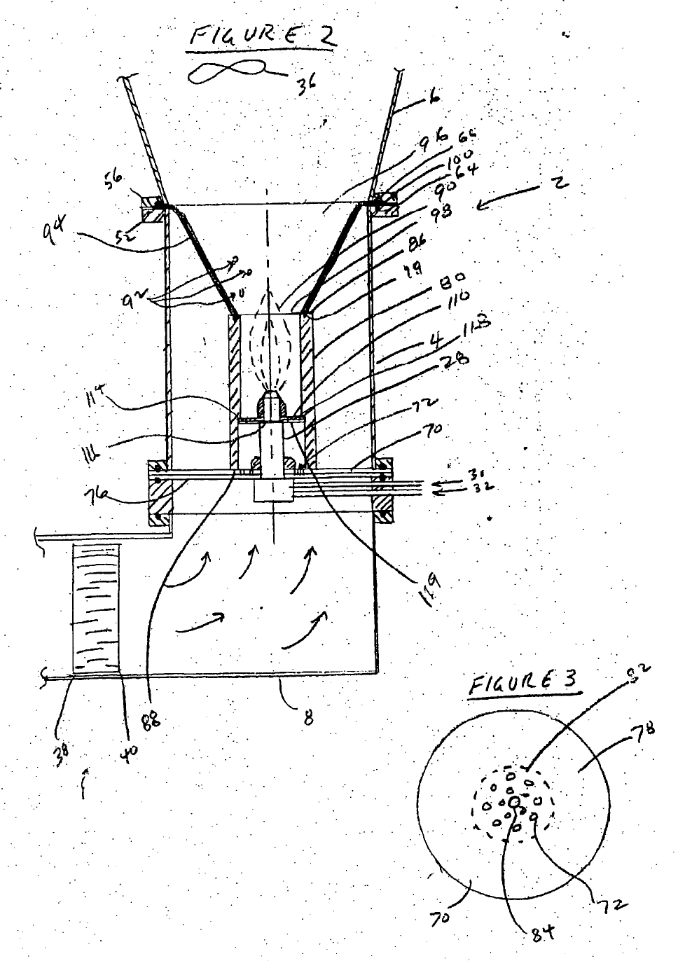

Referring now to FIG. 2, there is shown a side section view of the batch fluid bed processor 2 within the teachings of the present invention having an alternate embodiment kit to reduce the batch processors capacity. Referring also to FIG. 3, there is shown a top view of distribution plate 70. The batch fluid bed processor 2 includes a product container section 4, an expansion chamber 6 into which the upper end of the product container section 4 opens at an interface between the container section 4 and expansion chamber 6, and a lower plenum 8 disposed beneath the product container. A distribution plate and/or screen 70 is disposed between the container section 4 and the lower plenum 8. The distribution plate or screen 70 has a plurality of passage openings 72 through which air or gas from the lower plenum 8 may pass into the product container section 4. In alternate embodiments, a screen 76 may also be provided upstream of air distribution plate 70. Plate 70 does not have holes in the area 78 outside the cylindrical column 80. Plate 70 has holes 72 within the area 82 beneath cylindrical column 80. Holes 72 further away from pilot 84 may be smaller in diameter than the holes 72 closer to pilot 84. This results in higher air volumes and velocities in the central area of column 80. In alternate embodiments, any suitable shape and number of holes 72 may be provided. Although column 80 is shown with a cylindrical shape, other suitable shapes may be provided in alternate embodiments. Column 80 has open upper and lower ends, 86 and 88, the lower end 88 being seated on distribution plate 70. A secondary distribution plate and/or screen 110 is disposed between a shoulder 114 of column 80 and a shoulder 116 of nozzle 28. The distribution plate or screen 110 has a plurality of passage openings 118 through which air or gas from the lower plenum 8 may pass into the product container section 4. In alternate embodiments, a screen 119 may also be provided upstream of secondary distribution plate 110. Holes 118 further away from the center of secondary plate 110 may be smaller in diameter than the holes closer to the center. This results in higher air volumes and velocities in the central area of column 80. In alternate embodiments, any suitable shape and number of holes 118 may be provided. A spray nozzle assembly 28 is mounted at or through the distribution plate 70 and projects upwardly into the interior of the cylindrical column 80. The spray nozzle 28 receives a supply of gas under pressure through a gas supply line 30 and coating liquid line under pressure through a liquid supply line 32. The spray nozzle assembly 28 discharges a spray pattern 90 of gas and coating liquid. Air or gas is introduced into lower plenum 8 from blower or fan assembly 36. Air or gas may be filtered and/or heated by passing through heat exchanger 38 and/or filter 40. Air or gas introduced into the lower plenum 8 passes upwardly through the openings 72 formed through the air distribution plate or screen 70. Products or substances 92 such as powders and/or liquids that are to be coated, mixed, granulated or dryed are placed in product container 4 while air or gas is circulated through container 4 in and above column 80. Particles passing upwardly that enter into the spray pattern 90 are coated when spray pattern is active. An expansion funnel 94 is inserted and located downstream column 80. Expansion funnel 94 has an open upper end 96 and an open lower end 98 with the open upper end 96 being located downstream the open lower end 98. Products or substances 92 are isolated from the volume outside of column 80 by a combination of expansion funnel 94, column 80 and secondary distribution plate 70. In the embodiment shown, expansion funnel 94 is conical in shape. In alternate embodiments, any suitable shape may be provided. The open lower end 98 of expansion funnel 94 is seated on the open upper end 86 of column 80. A seal 99 may be provided to seal the open lower end 98 of expansion funnel 94 with the open upper end 86 of column 80. The open upper end 96 of expansion funnel 94 has a flange 100 captured at the interface between the flange 52 of the upper end of the product container section 4 and the flange 56 of the lower end of expansion chamber 6. Seal 64 and/or seal 66 may be provided to seal flange 52 to flange 56 and/or flange 100 of expansion funnel 94. By inserting expansion funnel 94 into the batch fluid bed processor 2, the effective area of the base of expansion chamber 6 is reduced from the cross section area of the opening in flange 56 to the cross section area of lower end 98 of expansion funnel 94. As a result, smaller quantities of product may be processed in the batch fluid bed processor 2 with the combination expansion chamber 6 and expansion funnel 94 and column 80 than with the expansion funnel 94 and column 80 not present. With the use of expansion funnel 94 and column 80, a tool that is designed to handle larger batches, such as in the kilogram range, may be easily modified in order to process smaller batches, for example, in the less than 100 gram range without having to supply a smaller tool that requires additional capital investment and may not offer the full capabilities of the larger tool. As a result, a batch fluid bed processor can be made capable of processing a wider range of batches allowing the same tool for use in both production and R&D pharmaceutical applications.

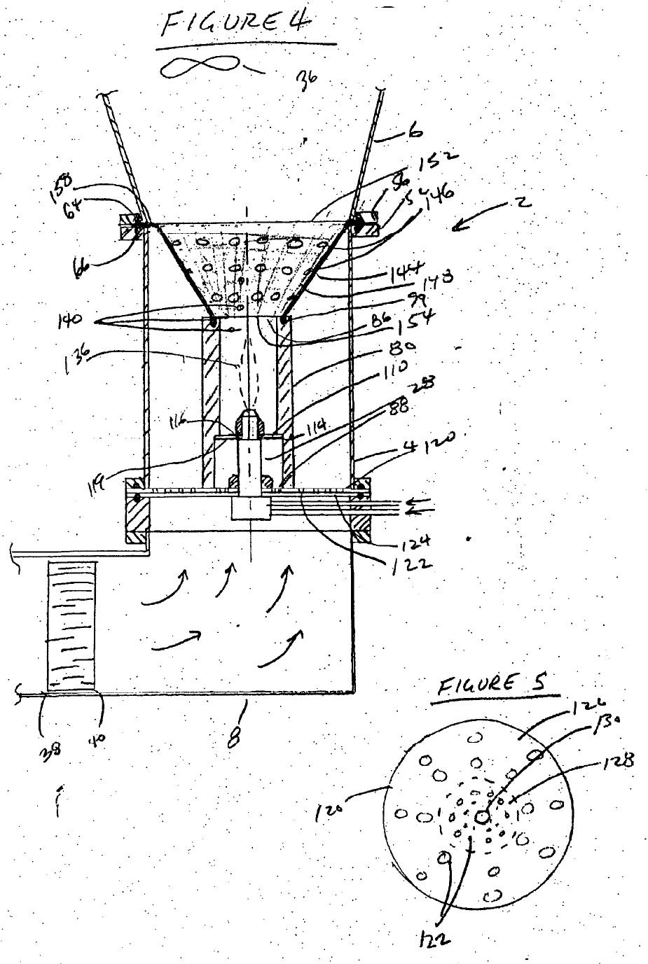

Referring now to FIG. 4, there is shown a side section view of the batch fluid bed processor 2 within the teachings of the present invention having an alternate embodiment kit to reduce the batch processors capacity. Referring also to FIG. 5, there is shown a top view of distribution plate 120. The batch fluid bed processor 2 includes a product container section 4, an expansion chamber 6 into which the upper end of the product container section 4 opens at an interface between the container section 4 and expansion chamber 6, and a lower plenum 8 disposed beneath the product container. A distribution plate and/or screen 120 is disposed between the container section 4 and the lower plenum 8. The distribution plate or screen 120 has a plurality of passage openings 122 through which air or gas from the lower plenum 8 may pass into the product container section 4. In alternate embodiments, a screen 124 may also be provided upstream of air distribution plate 120. Plate 120 has holes both in the area 126 outside the cylindrical column 80 and within the area 128 beneath cylindrical column 80. Holes 122 further away from pilot 130 may be smaller in diameter than the holes 122 closer to pilot 130. This results in higher air volumes and velocities in the central area of column 80. In alternate embodiments, any suitable shape and number of holes 122 may be provided. Column 80 has open upper and lower ends, 86 and 88, the lower end 88 being seated on distribution plate 120. A secondary distribution plate and/or screen 110 is disposed between a shoulder 114 of column 80 and a shoulder 116 of nozzle 28. In alternate embodiments, a screen 119 may also be provided upstream of secondary distribution plate 110. A spray nozzle assembly 28 is mounted at or through the distribution plate 120 and projects upwardly into the interior of the cylindrical column 80. The spray nozzle assembly 28 discharges a spray pattern 136 of gas and coating liquid. Air or gas is introduced into lower plenum 8 from blower or fan assembly 36. Air or gas may be filtered and/or heated by passing through heat exchanger 38 and/or filter 40. Air or gas introduced into the lower plenum 8 passes upwardly through the openings 122 formed through the air distribution plate or screen 120. Products or substances 140 such as powders and/or liquids that are to be coated, mixed, granulated or dryed are placed in product container 4 while air or gas is circulated through container 4 in and above column 80 and surrounding column 80. Particles passing upwardly that enter into the spray pattern 136 are coated when spray pattern is active. An expansion funnel 144 is inserted and located downstream column 80. Expansion funnel 144 has a plurality of passage openings 146 through which air or gas from the lower plenum 8 may pass through the product container section 4 and through expansion funnel 144. In alternate embodiments, a screen 148 may also be provided upstream or downstream of expansion funnel 144. In alternate embodiments, expansion funnel 144 may be made from a screen material instead of a perforated material. Holes 146 may have smaller holes further away the centerline in diameter than the holes closer to the centerline This results in higher air volumes and velocities in the central area of column 80. In alternate embodiments, any suitable shape and number of holes 146 may be provided. Products or substances 140 are isolated from the volume outside of column 80 by a combination of expansion funnel 144, column 80 and secondary distribution plate 110. Air or gas, in this embodiment, may pass through container 4 on both sides of column 80 and through expansion funnel 144. Expansion funnel 144 has an open upper end 152 and an open lower end 154 with the open upper end 152 being located downstream the open lower end 154. In the embodiment shown, expansion funnel 144 is conical in shape. In alternate embodiments, any suitable shape may be provided. The open lower end 154 of expansion funnel 144 is seated on the open upper end 86 of column 80. A seal 99 may be provided to seal the open lower end 154 of expansion funnel 144 with the open upper end 86 of column 80. The open upper end 152 of expansion funnel 144 has a flange 158 captured at the interface between the flange 52 of the upper end of the product container section 4 and the flange 56 of the lower end of expansion chamber 6. Seal 64 and/or seal 66 may be provided to seal flange 52 to flange 56 and/or flange 158 of expansion funnel 144. By inserting the combination of expansion funnel 144, plate 120 and column 80 into the batch fluid bed processor 2, a larger volume of gas or air may be transferred while still having the amount of product 140 to be processed reduced while maintaining product processing parameters such as heat and air or gas flow consistent with processing requirements. As a result, smaller quantities of product may be processed in the batch fluid bed processor 2 with the combination present than with the combination not present. Accordingly, a tool that is designed to handle larger batches, such as in the kilogram range, may be easily modified in order to process smaller batches, for example, in the less than 100 gram range without having to supply a smaller tool that requires additional capital investment and may not offer the full capabilities of the larger tool. As a result, a batch fluid bed processor can be made capable of processing a wider range of batches allowing the same tool for use in both production and R&D pharmaceutical applications.

It should be understood that the foregoing description is only illustrative of the invention. Various alternatives and modifications can be devised by those skilled in the art without departing from the invention. Such alternatives or modifications could be combining different expansion funnels with different columns or no columns as an example. Such alternatives or modifications could be mounting the expansion funnel further within the expansion chamber or product container as a further example. Accordingly, the present invention is intended to embrace all such alternatives, modifications and variances which fall within the scope of the appended claims.

What is claimed is:

1. A batch fluid bed processing machine for processing products, the batch fluid bed processing machine comprising:
a container;
a gas source coupled to a first end of the container;
an expansion chamber coupled to a second end of the container;
an expansion funnel having a second open end coupled to an interface between the expansion chamber and the container; and
a column mounted in the container between the expansion funnel and the gas source;
wherein, a gas stream is passed from the gas source and through the container and wherein products may be coated or dried in said gas stream.
